(19) United States
(12) Patent Application Publication
(10) Pub. No.: US 2011/0165897 A1
(43) Pub. Date: Jul. 7, 2011

(54) ENHANCED DATA PUSH CAPABILITIES SYSTEM AND METHOD

(76) Inventor: Stephen J. Zitnik, Fort Myers, FL (US)

(21) Appl. No.: 12/992,242

(22) PCT Filed: May 12, 2009
(86) PCT No.: PCT/US2009/043557

§ 371 Date: Feb. 14, 2011

Related U.S. Application Data
(60) Provisional application No. 61/052,503, filed on May 12, 2008.

(51) Int. Cl. H04W 4/12

(52) U.S. Cl. 455/466

(57) ABSTRACT

An Enhanced Data Push Capabilities (EDPC) system and method are disclosed. A Data Push Gateway (DPG) controls connectivity instructions and delivery of data messages to EDPC enabled cellular handsets. Data content from data sources such as Instant Messaging (IM)1 Email, Short Messaging Service Center (SMSC), and Multimedia Messaging Service Center (MMSC) can be delivered to or accessed by cellular handsets without using any voice resources of the cellular network infrastructure, reducing network voice traffic and improving network efficiency. Only network data resources are used for session setup and delivery of data traffic.

### CROSS-REFERENCE TO RELATED APPLICATIONS

This application claims the benefit of priority of United States Provisional Patent Application No. 61/052,503, filed May 12, 2008. The full disclosure of United States Provisional Patent Application No. 61/052,503 is hereby incorporated herein by reference.

### FIELD OF THE INVENTION

The present invention relates generally to a system and method for improving the data push capabilities within wireless communication networks, and has particular application in cellular networks.

### BACKGROUND OF THE INVENTION

Within current Code-Division Multiple Access (CDMA) and Global System Mobile (GSM) data networks, two methods are already used for handset notification of available content on the data network.

A first and most widely used method is often referred to in the industry as WAP PUSH. Utilizing this methodology, a WAP PUSH message in the form of an SMS message is delivered to the handset utilizing network voice resources. This specially crafted binary SMS message contains instructions for the content download. This WAP PUSH message instructs the handset to access the data network and retrieve the waiting content data from the Uniform Resource Locator (URL) provided in the message. The handset operates in accordance with the instructions to download the content data.

While this methodology is widely used, and has been effective for many applications, it has its limitations. For example, this methodology requires the utilization of voice resources to notify the handset of available content data. In particular, this methodology uses the SMS service center (SMSC) to send multiple Short Messaging Service (SMS) messages across the Signaling System #7 (SS7) and over-the-air (OTA) networks in order to facilitate content downloads. It is desirous to increase the efficiency of the content notification process in order to reduce the reliance on already strained SMS resources, as well as to reduce the utilization of valuable voice traffic channel resources.

A second methodology commonly used is referred to as polling. In this scheme, the software application on the handset periodically accesses the data network and polls the data source in order to ascertain if new data or instructions are available.

While this methodology is widely used as well, it has at least two limitations. First, the constant polling scheme over utilizes the data network, particularly if a single widely used application polls at a constant interval. Second, this method of constant polling has a tremendously adverse effect on handset battery life. The constant polling requires the handset to spend an excessive amount of time in active mode, where battery energy is consumed at a higher rate, versus idle state mode.

While these prior data push capabilities have worked, it would be desirable to provide data push capabilities that reduce the use of voice traffic channel resources, that provide efficient use of the data network, that maximize handset battery life, that are easy to use and that do not require substantial modification of existing network infrastructure.

### SUMMARY OF THE INVENTION

The system and method described herein is referred to as Enhanced Data Push Capabilities (EDPC). EDPC utilizes existing wireless communication network infrastructure, such as cellular paging network infrastructure for example. EDPC requires minimal additional cellular infrastructure resources. EDPC also utilizes existing wireless techniques, such as cellular paging techniques for example. EDPC requires minimal modifications to wireless devices, such as cellular handsets for example.

In one aspect, EDPC utilizes new Internet Protocol (IP) based network infrastructure.

In another aspect, EDPC utilizes new IP based protocols.

In yet another aspect, EDPC provides a Data Push Gateway.

In a further aspect, EDPC provides supporting software on wireless devices.

In another aspect, EDPC provides that all data transfer including messaging traffic, content, push email and other IP services utilize only the data network during session setup and delivery. Voice resources are not utilized for data session setup and delivery, and only data resources are utilized for session setup and delivery of data traffic.

### BRIEF DESCRIPTION OF THE DRAWINGS

In the following detailed description, reference will frequently made to the following figures, in which like reference numerals refer to like components, and in which:

FIG. 1 is a diagrammatic view of a typical wireless infrastructure layout;

FIG. 2 is a diagrammatic view of an embodiment of a wireless infrastructure layout of the present invention; and

FIG. 3 is a flow diagram illustrating a method of carrying out principles of the present invention.

### DETAILED DESCRIPTION OF THE DRAWINGS

As described herein, hardware and software can be used to deliver data to a target wireless device, such as a cellular handset for example. Also, hardware and software can be used to instruct a target wireless device or cellular handset as to where to pick up data. Further, hardware and software can be used to instruct a target wireless device to attach to another endpoint in the data network.

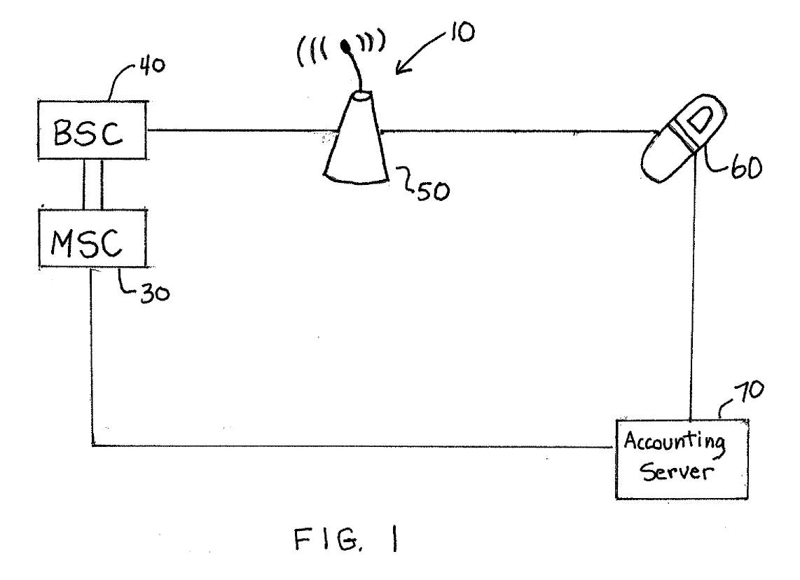

As shown in FIG. 1, a wireless infrastructure network generally designated as 10 includes a Mobile Switching Center (MSC) 30 associated with a Base Station Controller (BSC) 40. The wireless infrastructure network can be a cellular infrastructure network for example. In the illustrated embodiment, the BSC 40 is in communication with a wireless broadcast antenna 50. Wireless broadcast antenna 50 can be a cellular broadcast antenna for example. Wireless broadcast antenna 50 can be located on stand-alone cellular towers, water towers, radio antennas or buildings for example. Each wireless broadcast antenna 50 has a range of service and multiple wireless broadcast antennas 50 are typically spaced within a geographical area to maximize the coverage range of the cellular network. Wireless broadcast antenna 50 can be in wireless communication with a wireless device 60, such as a cellular handset for example, that is within the range of service for that wireless broadcast antenna 50. Two-way communication can thus be carried out between the BSC 40 and wireless device 60. An accounting server 70 can be used to provide connection information such as connection time and connection location for example.

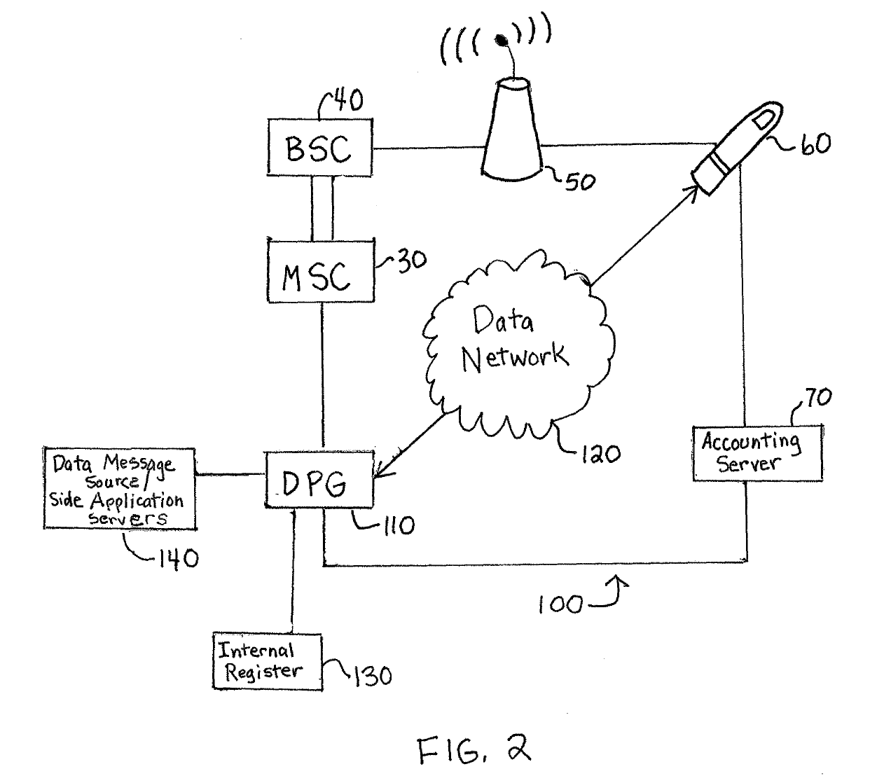

FIG. 2 illustrates an embodiment of an enhanced wireless infrastructure network, generally designated 100. The enhanced wireless infrastructure network 100 can be a cellular infrastructure network for example. The illustrated embodiment of the enhanced wireless infrastructure network 100 utilizes the network infrastructure described above, including MSC 30, BSC 40, wireless broadcast antenna 50 and accounting server 70. The enhanced wireless infrastructure network 100 may also include a wireless device 60. Wireless device 60 can be a cellular handset for example. Alternatively, wireless device 60 could be any other wireless device such as a laptop computer, a computer attached to or embedded in a vehicle, or a headset for example. In addition to the elements referenced above, enhanced wireless infrastructure network 100 includes a Data Push Gateway (DPG) 110. The DPG 110 is responsible for delivering data to the wireless device 60. Also, the DPG 110 is responsible for instructing the wireless device 60 as to where to pick up or retrieve data. Further, the DPG 110 is responsible for instructing the cellular handset 60 to attach to another endpoint in the enhanced wireless infrastructure network 100. The DPG 110 can perform each of these operations with a target wireless device 60 separately or simultaneously. For example, the DPG 110 can deliver specific data to the wireless device 60 while also instructing the wireless device 60 to pick up other data from another data source in a data network 120.

The DPG 110 of the illustrated embodiment is also responsible for maintaining a record of each wireless device 60 currently on the data network 120 in its internal register 130, based upon information forwarded thereto. The internal register 130 may be a Mobile Directory Number/Internet Protocol (MDN/IP) address-mapping internal register for example. The DPG 110 may be backward compatible with existing messaging and content delivery platforms through the support of currently utilized standards-based communication protocols well known in the art, such as Short Message Peer-to-Peer protocol (SMPP), Signaling System 7 (SS7), Simple Mail Transfer Protocol (SMTP) and Third Generation Partnership Project (3GPP) interfaces such as MM7 and MM4 for example. The DPG 110 may be compatible with any other industry standard communications protocols as well.

The DPG 110 communicates with wireless device 60 over Internet Protocol (IP) resources. The DPG 110 does not utilize any voice based network resources to communicate with wireless device 60. The DPG 110 and the wireless device 60 utilize a protocol using known technologies and programming techniques to communicate, such as an Extensible Markup Language (XML) based protocol for example. The DPG 110 compatible protocol can be enabled on a wireless device 60 by the addition of a software application for example. Alternatively, the DPG 110 compatible protocol can be provided in the firmware of a wireless device 60 for example. The wireless device 60 can be manufactured or distributed as a DPG enabled or compatible device for example. Alternatively, the DPG enabling or compatibility application can be distributed or downloaded as an after market software add-on for example. DPG enabled or compatible devices may also be referred to as EDPC enabled or compatible.

Communication with a wireless device 60 may be initiated by the DPG 110. The DPG 110 utilizes commands to control the behavior of the wireless device 60. Primary commands such as MESSAGE, GET AND ATTACH may be used for example. Each command of the illustrated embodiment may be named in accordance with the functionality of the command for example.

The command MESSAGE may be utilized to deliver any message type to the wireless device 60 from the DPG 110. The message delivered to the wireless device 60 is generally perceptible to the wireless device 60 user and can be of any existing or later developed type, such as text, pictures, and videos for example. The delivered message can be a combination of data types as well, such as pictures with accompanying text for example.

The command GET may be used to instruct the wireless device 60 to get (or download) content from a specific URL typically embedded within the command. As an example, this command can be used to instruct the wireless device 60 to retrieve a Multimedia Messaging Service (MMS) message from a legacy platform.

The command ATTACH may be used to instruct the wireless device 60 to attach to another network node, server or handset over the data network 120, such as an IP network for example, This can enable peer-to-peer applications, such as direct connectivity between wireless devices 60 for example.

Communication may also be initiated by a wireless device 60 within the network. For example, the command MESSAGE may be used to provide for delivery of a data message to another DPG enabled device such as another DPG enabled wireless device 60 or a DPG attached legacy server.

As shown in FIG. 2, the DPG 110 can provide connectivity to a variety of data sources such as network side application servers 140. For example, the DPG 110 can connect with a network side application server 140 such as a Short Messaging Service Center (SMSC), a Multimedia Messaging Service Center (MMSC), an Instant Messaging (IM) Service or an E-mail server. The DPG 110 can function as a gateway directly between a selected network side application server 140 and a wireless device 60 for example.

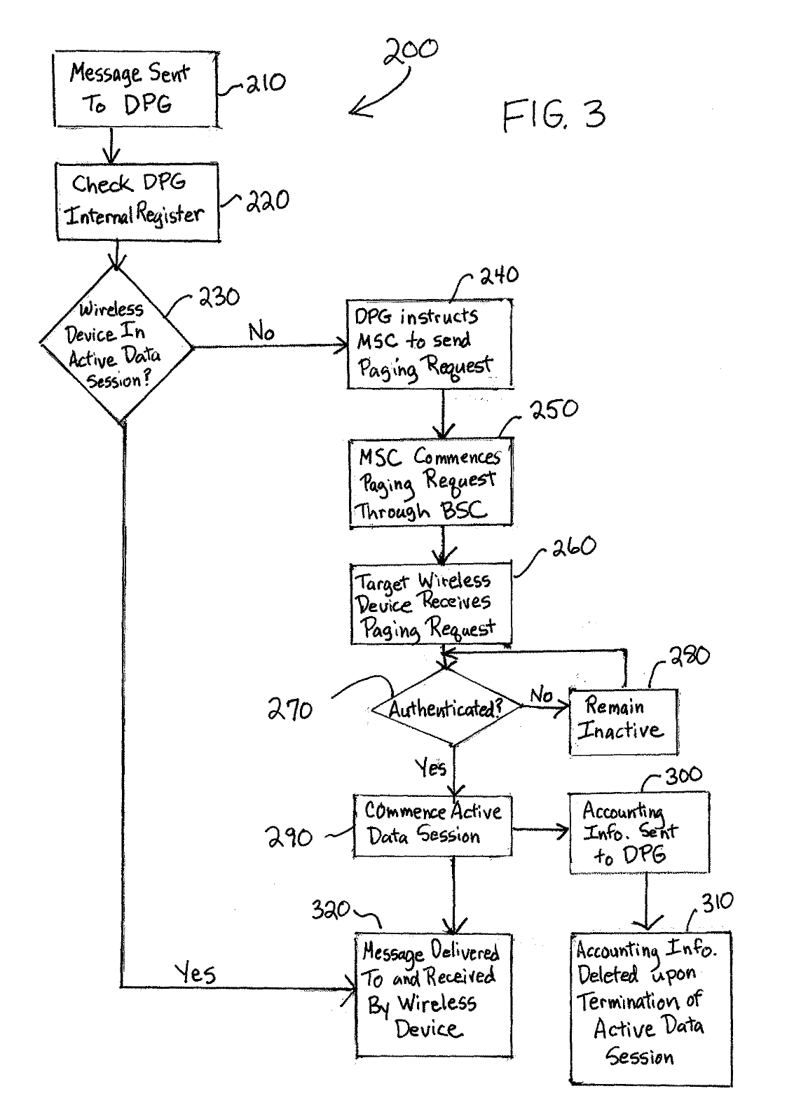

FIG. 3 illustrates a method of carrying out the Enhanced Data Push Capabilities of the present invention, generally designated 200. Reference is to be made to FIG. 2 for identification of network elements.

In Step 210, a data message destined for delivery to a target EDPC enabled wireless device 60 from a legacy SMS handset is sent to the DPG 110. For these purposes, the transport might utilize Short Message Peer-to-Peer (SMPP) protocol for example.

In Step 220, the DPG 110 checks its internal register 130 and in Step 230 determines if the target EDPC enabled wireless device 60 is already in a data session. The internal register 130 of the DPG 110 is driven by the existing accounting server 70, such as an AAA/RADIUS server of a wireless carrier for example. Accounting information used to indicate that target wireless device 60 is in a data session is forwarded to the DPG 110. As a result, the DPG 110 can determine, as reflected by Step 230, whether the target EDPC enabled wireless device 60 to which the message is to be delivered is in a data session. This step is referred to as the forward accounting information functionality of the EDPC system and method.

It will be appreciated that this functionality may be carried out in several different ways. For example, the DPG 110 may be configured to accept accounting and IP information from a plurality of existing sources, including RADIUS or DIAMETER for example. If the target EDPC enabled wireless device 60 is already in a data session, the message to be delivered is sent directly over the data network 120 directed to the IP and the dedicated push port of the EDPC enabled wireless device 60, as described hereinafter with reference to Step 320.

If the wireless device 60 does not currently have an active data session, Step 240 is performed and the DPG 110 will instruct the Mobile Switching Center (MSC) 30 to initiate a paging request to the target EDPC-enabled wireless device 60, requesting such wireless device to commence a data session. This can be an SS7 message sent to the MSC 30 serving the EDPC enabled wireless device 60, as determined by a Home Location Register (HLR) query for example.

In Step 250, driven by the paging request command from the DPG 110, the MSC 30 will initiate a paging request through an associated BSC 40. In a preferred embodiment, this paging request has the Service Option field set to 0x40 0x07 as defined in IS-634.9 (Internet service option), which field will instruct the target EDPC enabled wireless device 60 to commence an active data session. It will be appreciated that any valid and agreed upon service option may be used to initiate an active data session.

In Step 260, the target EDPC enabled wireless device 60 receives the paging request. Thereafter, it is determined in Step 270 whether the target EDPC enabled wireless device 60 has received authentication from the accounting server 70. The target EDPC enabled wireless device 60 remains in an inactive state until it receives authentication from the accounting server 70, as reflected by Step 280.

Upon receipt of such authentication, the target EDPC enabled wireless device 60 commences an active data session by accessing the data network 120 through any industry standard procedures. Once authenticated on the data network, the target EDPC enabled wireless device 60 listens on its preconfigured dedicated push port. This port may be any unused port agreed upon between the DPG 110 and the wireless device 60. For convenience, the push port may be set to 7874 (“PUSH”) for example.

In Step 300, the accounting information is forwarded from the accounting server 70 to the DPG 110 at the time of target wireless device 60 registration on the data network 120. This information will be stored in the DPG internal registry 130 and may be deleted when the accounting server 70 later notifies the DPG 110 of the termination of the active data session for the target EDPC enabled wireless device 60, as reflected by Step 310.

In Step 320, the wireless device 60 and DPG 110 communicate over Transmission Control Protocol/Internet Protocol (TCP/IP) using the selected EDPC protocol. The message is thereby delivered to, and received by, the target EDPC-enabled wireless device 60.

While this invention has been described as having certain illustrative features, it will be understood that this description shall not be construed in a limiting sense. It will be appreciated that those skilled in the art will recognize equivalents to one or more elements of the following claims, which claims shall be construed to the fullest extent permitted by law.

That which is claimed:

1. An Enhanced Data Push Capabilities (EDPC) wireless network system comprising:
a Mobile Switching Center (MSC);
a Base Station Controller (BSC) in communication with the MSC;
an accounting server;
a wireless broadcast antenna in communication with the BSC;
a data message source; and
a Data Push Gateway (DPG), wherein the DPG is in communication with the accounting server, the MSC and the data message source.

2. The EDPC wireless network system of claim 1, further comprising an EDPC enabled wireless device.

3. The EDPC wireless network system of claim 2, wherein the EDPC enabled wireless device is a cellular handset.

4. The EDPC wireless network system of claim 2, wherein the EDPC enabled wireless device is in communication directly with the DPG.

5. The EDPC wireless network system of claim 1, wherein the data message source is an Email server.

6. The EDPC wireless network system of claim 1, wherein the data message source is an Instant Messaging (IM) Service.

7. The EDPC wireless network system of claim 1, wherein the data message source is a Multimedia Messaging Service Center (MMSC).

8. The EDPC wireless network system of claim 1, wherein the data message source is a Short Messaging Service Center (SMSC).

9. The EDPC wireless network system of claim 1, wherein the data message source is another EDPC enabled wireless device.

10. A method for providing a data message to an Enhanced Data Push Capabilities (EDPC) enabled wireless device over an EDPC wireless network system, the steps comprising:
transferring a data message from a data source to a Data Push Gateway (DPG);
determining whether the EDPC enabled wireless device is currently in an active data session;
commencing an active data session for said EDPC enabled wireless device in the event said EDPC enabled wireless device is not in an active data session and utilizing only data resources of said EDPC wireless network system to commence the active data session for said EDPC enabled wireless device;
transferring the data message from the DPG to the EDPC enabled wireless device when said EDPC enabled wireless device is in said active data session and utilizing only data resources of said EDPC wireless network system to transfer said data message from the DPG to the EDPC enabled wireless device.

11. The method as defined in claim 10, wherein the transfer of data from said data source to said DPG utilizes Short Message Peer-to-Peer (SMPP) protocol.

12. The method as defined in claim 10, further comprising the step of utilizing an accounting server and an internal register of said DPG to determine whether said EDPC enabled wireless device is in said active data session.

13. The method as defined in claim 10, wherein the transfer of data from said DPG to said EDPC enabled wireless device utilizes Transmission Control Protocol/Internet Protocol (TCP/IP).

14. A method for providing a data message to an Enhanced Data Push Capabilities (EDPC) enabled wireless device over an EDPC wireless network system, the steps comprising:
transferring a data message from a data source to a Data Push Gateway (DPG);
determining whether the EDPC enabled wireless device is currently in an active data session;
commencing an active data session for said EDPC enabled wireless device in the event said EDPC enabled wireless device is not in an active data session and utilizing only data resources of said EDPC wireless network system to commence the active data session for said EDPC enabled wireless device, by sending a paging signal to the EDPC enabled wireless device, requesting the EDPC enabled wireless device to commence an active data session;
transferring the data message from the DPG to the EDPC enabled wireless device when said EDPC enabled wireless device is in said active data session and utilizing only data resources of said EDPC wireless network system to transfer said data message from the DPG to the EDPC enabled wireless device, wherein the EDPC enabled wireless device listens on a preconfigured dedicated push port thereof for the data message.

15. The method as defined in claim 14, wherein the transfer of data from said data source to said DPG utilizes Short Message Peer-to-Peer (SMPP) protocol.

16. The method as defined in claim 14, the DPG sends a SS7 message to a MSC instructing the MSC to initiate the paging signal.

17. The method as defined in claim 16, wherein the SS7 message to the MSC is determined by a Home Location Register (HLR) query.

18. The method as defined in claim 16, wherein the MSC causes a BSC to send the paging signal, which has a Service Option field setting of 0x40 0x07 as defined in IS- 634.9 instructing the EDPC enabled wireless device to commence an active data session.

19. The method as defined in claim 14, wherein the preconfigured dedicated push port of the EDPC enabled wireless device is set to 7874 (“PUSH”).

20. The method as defined in claim 14, wherein the transfer of data from said DPG to said EDPC enabled wireless device utilizes Transmission Control Protocol/Internet Protocol (TCP/IP).
